(19) United States
(12) Patent Application Publication
(10) Pub. No.: US 2026/0249934 A1
(43) Pub. Date: Aug. 27, 2026

(54) TRACK ASSEMBLY, VEHICLE HAVING SAME, WHEEL, AND ENDLESS TRACK FOR USE WITH SAME

(71) Applicant: SOUCY INTERNATIONAL INC., Drummondville (CA)

(72) Inventors: Marc-Antoine LEBLANC, Drummondville (CA); Francois LAFLAMME, St-Germain-De-Grantham (CA); Magella BEDARD, Drummondville (CA); Remi HAMELIN, Trois-Rivieres (CA); Olivier LECLERC, Drummondville (CA)

(21) Appl. No.: 18/871,266

(22) PCT Filed: Jul. 14, 2023
(86) PCT No.: PCT/CA2023/050954

§ 371 Date: Dec. 3, 2024

Related U.S. Application Data
(60) Provisional application No. 63/392,229, filed on Jul. 26, 2022.

(51) Int. Cl. B62D 55/24; B62D 55/12

(52) U.S. Cl. CPC B62D 55/244; B62D 55/12; B62D 55/242

(57) ABSTRACT

Track assemblies, wheels, endless tracks and track assembly conversion kits are disclosed. One track assembly includes a wheel, which has a rim and a plurality of engaging elements, defines a plurality of grooves, and an endless track including a body and a plurality of lugs extending outwardly from a first lateral side of the body. Each lug of the plurality of lugs is sized and shaped to be received in a respective groove of the plurality of grooves such that, a given one lug of the plurality of lugs extends across the rim of the wheel to be received in the respective groove. One elastomeric endless track has a body, a plurality of longitudinally spaced driving lugs extending from the body, and a plurality of longitudinally spaced outer lugs extending from an outer face of the body, the outer lugs being longitudinally offset from the driving lugs.

### TECHNICAL FIELD

The present application generally relates to wheels for track assemblies, endless tracks for wheel assemblies, track assemblies, and vehicles having said track assemblies.

### BACKGROUND

Various vehicles, such as military vehicles or agricultural vehicles come equipped with track assemblies instead of tires for a variety of reasons, notably to have enhanced traction on various ground surfaces that are soft, slippery and/or uneven (e.g., soil, mud, sand, ice, snow, etc.).

Conventionally, the track assemblies in some of these vehicles, particularly military vehicles, come equipped with metal endless tracks and wheels. These metal endless tracks can be heavy, burdensome to install, can make a lot of noise, and can cause a lot of vibrations, which can reduce life of some components of the vehicle while also negatively impacting ride quality.

Therefore, there is desire for a track assembly that could mitigate the above-mentioned issues.

### SUMMARY

It is an object of the present technology to ameliorate at least some of the inconveniences present in the prior art.

According to one aspect of the present technology, there is provided a track assembly for a track vehicle. The track assembly includes a wheel and an endless track. The wheel, which has a rim and a plurality of engaging elements extending radially outwardly from the rim, defines a plurality of grooves therebetween. The endless track, which is engageable with the wheel, has a reinforced elastomeric construction, and includes a body and a plurality of lugs. The body has a longitudinal plane, and includes an outer face for contacting a ground, an inner face opposite to the outer face, a first lateral face extending between the inner and outer faces, and a second lateral face opposite to the first lateral face, and extending between the inner and outer faces. The plurality of lugs, which extend outwardly from the first lateral side, are longitudinally spaced from one another along the first lateral face. Each lug of the plurality of lugs is sized and shaped to be received in a respective groove of the plurality of grooves such that, a given one lug of the plurality of lugs extends across the rim of the wheel to be received in the respective groove.

In some embodiments, the endless track includes a plurality of guide lugs extending from the inner surface.

In some embodiments, the plurality of guide lugs is generally positioned parallel to a direction of the longitudinal plane of the body.

In some embodiments, the endless track further comprises a plurality of reinforcing elements, each one of the plurality of reinforcing elements extending across a width of the endless track, and having a central reinforcing portion reinforcing a respective one of the plurality of guide lugs.

In some embodiments, the endless track further comprises a plurality of reinforcing elements, each one of the plurality of reinforcing elements extending across a width of the endless track.

In some embodiments, each one of the plurality of reinforcing elements extends from a first laterally outermost segment of the endless track to a second laterally outermost segment of the endless track.

In some embodiments, each one of the plurality of reinforcing elements is generally flat.

In some embodiments, each one of the plurality of reinforcing elements has an engaging portion for reinforcing a respective one of the plurality of lugs, and for engaging with the wheel.

In some embodiments, each one of the plurality of reinforcing elements has a central reinforcing portion.

In some embodiments, the reinforcing element has an interlocking feature for interlocking with the body.

In some embodiments, the endless track further comprises at least one reinforcing member extending longitudinally along the length of the endless track.

In some embodiments, the at least one reinforcing member is at least one layer of reinforcing members.

In some embodiments, the at least one layer of reinforcing members is a layer of reinforcing cords.

In some embodiments, when one of the plurality of lugs is received in one of the plurality of grooves, an inner surface of the one of the plurality of lugs is spaced from a bottom of the groove.

In some embodiments, the plurality of lugs defines a plurality of gaps, and when the wheel and the endless track are engaged to one another, one of the plurality of engaging elements is received in one of the plurality of gaps.

In some embodiments, the rim has a first annular rim portion and a second annular rim portion, the plurality of engaging elements extend from the second annular rim portion, and when the wheel is operatively connected to the endless track, a portion of the inner face of the endless track is supported on the first annular rim portion.

In some embodiments, the plurality of engaging elements of the wheel is a first plurality of engaging elements and the plurality of grooves defined therebetween is a first plurality of grooves, and the wheel further comprises a second plurality of engaging elements extending radially outwardly from the rim and defining a second plurality of grooves therebetween. Additionally, the plurality of lugs of the endless track is a first plurality of lugs, and the endless track further comprises a second plurality of lugs extending outwardly from the second lateral side, the second plurality of lugs being longitudinally spaced from one another along the second lateral side. Each lug of the second plurality of lugs is sized and shaped to be received in a respective groove of the second plurality of grooves, and each lug of the second plurality of lugs is sized and shaped to be received in a respective groove of the second plurality of grooves such that, a given one lug of the second plurality of lugs extends across the rim of the wheel to be received in the respective groove.

In another aspect of the present technology, there is provided a vehicle comprising a body; an engine supported by the body; and at least two track systems according to the above aspect or according to the above aspect and one or more of the above embodiments. The at least two track systems being operatively connected to the engine.

In some embodiments, the vehicle is a military vehicle.

According to another aspect of the present technology, there is provided a replacement wheel for replacing a wheel adapted for a metallic track. The replacement wheel, which is configured to be in a driving engagement with an endless track, includes a rim and a plurality of engaging elements. The rim has a first annular rim portion and a second annular rim portion. The plurality of engaging elements, which is disposed circumferentially around the second annular rim portion, extends radially outwardly from the second annular rim portion, and defines a plurality of grooves therebetween.

According to another aspect of the present technology, there is provided a wheel for a track assembly. The wheel has a rim having first annular rim portion and a second annular rim portion, and a plurality of engaging elements disposed circumferentially around the second annular rim portion. The plurality of engaging elements extending radially outwardly from the first annular rim portion and defining a plurality of grooves therebetween. The wheel also has an axis of rotation. In some embodiments, a first radius is defined from the axis of rotation to a bottom of the groove, a second radius is defined from the axis of rotation to an apex of one of the engaging elements, and a third radius is defined from the axis of rotation to a radial surface of the first annular portion.

In some embodiments, the third radius is greater than the first radius.

According to another aspect of the present technology, there is provided a track assembly including a wheel according to the above aspect or according to the above aspect and one or more of the above embodiments, and an endless track engageable to the wheel. The endless track has a body and a plurality of lugs. The body has an outer face for contacting a ground, and an inner face opposite the outer face, a portion of the inner face being configured to engage the first annular rim portion, a first lateral face, and a second lateral face opposite the first lateral face. The plurality of lugs, which extend outwardly from the first lateral side, are longitudinally spaced from one another along the first lateral face. In some embodiments, the endless track is positionable relative to the wheel such that when the inner face of the body contacts the first annular rim portion, one of the plurality of lugs is received in one of the plurality of grooves such that an inner surface of the one of the plurality of lugs is spaced from the bottom of the groove.

According to another aspect of the present technology, there is provided a military vehicle including a body, an engine supported by the body, and at least two track systems according to the above aspect. The at least two track systems are operatively connected to the engine.

According to another aspect of the present technology, there is provided a track assembly conversion kit for a tracked vehicle having an original wheel and an original endless track. The track assembly conversion kit includes a replacement wheel for replacing the original wheel, and a replacement endless track for replacing the original endless track. The replacement wheel, which is operatively connectable to the tracked vehicle, includes a rim and a plurality of engaging elements extending radially outwardly from the rim and defining a plurality of grooves therebetween. The replacement endless track is operatively connectable to the tracked vehicle, and is engageable with the replacement wheel. The replacement endless track has a reinforced elastomeric construction, and includes a body and a plurality of lugs. The body has an outer face for contacting a ground, an inner face opposite to the outer face, a first lateral face, and a second lateral face opposite to the first lateral face. The plurality of lugs, which extend outwardly from the first lateral side, is longitudinally spaced from one another along the first lateral face. Each lug of the plurality of lugs is sized and shaped to be received in a respective groove of the plurality of grooves such that a given one lug of the plurality of lugs extends across the rim of the wheel to be received in the respective groove.

In some embodiments, a width of the replacement endless track is generally similar to a width of the original endless track.

In some embodiments, the original endless track is a metallic endless track.

In some embodiments, the tracked vehicle is a tank.

In some embodiments, the track assembly conversion kit further including instructions for replacing the original wheel with the replacement wheel, and for replacing the original endless track with the replacement endless track.

According to another aspect of the present technology, there is provided an endless track having a reinforced polymeric construction. The endless track includes a body, a plurality of longitudinally spaced lugs, a plurality of longitudinally spaced outer lugs, and a plurality of reinforcing elements. The body has a longitudinal plane, and including an outer face for contacting a ground, an inner face opposite to the outer face, a first lateral face extending between the inner and outer faces, and a second lateral face opposite to the first lateral face, and extending between the inner and outer faces. The plurality of longitudinally spaced lugs extends from the body. The plurality of longitudinally spaced outer lugs extends from the outer face, and the plurality of outer lugs defines channels therebetween. The plurality of reinforcing elements are disposed within the body, each one of the reinforcing elements being generally longitudinally aligned with a center axis of one of the channels.

In some embodiments, each channel extends across a width of the endless track.

In some embodiments, each channel has a first open end at the first lateral face and a second open end at the second lateral face, and a respective one of the plurality of reinforcing elements is generally longitudinally aligned with the first and second open ends.

In some embodiments, the plurality of lugs extends from the inner face.

In some embodiments, the plurality of lugs is generally positioned parallel to a direction of the longitudinal plane of the body.

In some embodiments, the plurality of lugs extends generally outwardly from at least one of the first and second lateral faces.

In some embodiments, each one of the plurality of lugs is longitudinally aligned with one of the reinforcing elements.

In some embodiments, each one of the plurality of reinforcing plates has an engaging portion for engaging with the wheel and for reinforcing the lugs.

In some embodiments, the body has a plurality of central guide lugs, and each one of the plurality of reinforcing elements has a central reinforcing portion for reinforcing one of the plurality of central guide lugs.

In some embodiments, each one of the plurality of reinforcing elements is generally flat.

In some embodiments, the reinforcing element further comprises an interlocking feature for interlocking with the body.

In some embodiments, the plurality outer lugs is a plurality of tread lugs.

In some embodiments, the body further comprises at least one layer of reinforcing members extending longitudinally along a length of the endless track.

In some embodiments, the at least one layer of reinforcing members is a layer of reinforcing cords.

In some embodiments, the plurality of reinforcing elements are embedded into the body.

According to another aspect of the present technology, there is provided a track assembly including a wheel operatively connectable to a vehicle, and an endless track according to the above aspect or according to the above aspect and one or more of the above embodiments. The endless track is engageable with the wheel.

According to another aspect there is provided a vehicle including a frame, an engine supported by the frame, and two track systems according to the above aspect. The two track systems are connected to the frame.

According to another aspect of the present technology, there is provided an endless track for a heavy vehicle. The endless track has an elastomeric reinforced construction, and includes a body, a plurality of outer lugs, a plurality of side lugs, and a plurality of reinforcing elements. The body has an outer face, an inner face opposite to the inner face, a first lateral face, and a second lateral face. The plurality of outer lugs extends from the outer face, and is longitudinally spaced from one another and defines outer grooves therebetween. The plurality of side lugs extends outwardly from the first lateral face, the plurality of side lugs being longitudinally spaced from one another, each one of the plurality of side lugs being longitudinally aligned with one of the outer grooves. The plurality of reinforcing elements is disposed in the elongate body, each one of the reinforcing elements being longitudinally aligned with one of the plurality of side lugs.

In some embodiments, the plurality of reinforcing elements are embedded in the body.

According to another aspect of the present technology, there is provided an elastomeric endless track for a track system. The elastomeric endless track includes a body, a plurality of longitudinally spaced driving lugs, and a plurality of longitudinally spaced outer lugs. The body has a longitudinal plane, and includes an outer face for contacting a ground, an inner face opposite to the outer face, a first lateral face extending between the inner and outer faces, and a second lateral face opposite to the first lateral face, and extending between the inner and outer faces. The plurality of longitudinally spaced driving lugs extends from the body. The plurality of longitudinally spaced outer lugs extend from the outer face of the body, the outer lugs being longitudinally offset from the driving lugs.

In some embodiments, the outer lugs are longitudinally offset from the driving lugs by about half a pitch between the driving lugs.

In some embodiments, the elastomeric endless track is configured to deform about a virtual axis extending generally at an angle to the inner and outer faces.

In some embodiments, the elastomeric endless track further includes a plurality of reinforcing elements, each of the plurality of reinforcing elements being received in one of the plurality of driving lugs.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track assembly and components in relation thereto, such as “vertical”, “horizontal”, “forwardly”, “rearwardly”, “left”, “right”, “above” and “below”, are as they would be understood by a driver of a vehicle to which the track assembly is connected, in which the driver is sitting on the vehicle in an upright driving position, with the vehicle steered straight-ahead and being at rest on flat, level ground.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1A is a perspective view of a military vehicle having track systems as known in the prior art;

FIG. 1B is a close-up perspective view of one of the track assemblies of FIG. 1A;

FIG. 2 is a perspective view taken from a top, front, left side of a track assembly conversion kit according to an embodiment of the present technology;

FIG. 3 is a perspective view taken from a top, front, left side of a sprocket wheel of the track assembly conversion kit of FIG. 2;

FIG. 4 is a left side elevation view of the sprocket wheel of FIG. 3;

FIG. 5 is a perspective view taken from a top, front, left side of a portion of an endless track of the track assembly conversion kit of FIG. 2;

FIG. 6 is a close-up perspective view taken from a top, front, left side of the portion of the endless track of FIG. 5, with part of the endless track being shown in transparency;

FIG. 7 is a front elevation view of the portion of the endless track of FIG. 5, with part of the endless track being shown in transparency;

FIG. 8 is a perspective view taken from a top, front, left side of an alternate embodiment of a portion of an endless track of the track assembly conversion kit of FIG. 2;

FIG. 9 is a perspective view of a portion of the endless track of FIG. 8 in engagement with a sprocket wheel according to an embodiment of the present technology; and

FIG. 10 is a right side elevation view of a portion of an endless track according to an endless track known in the endless track

FIG. 11 is a right side elevation view of a portion of an endless track according to an embodiment of an aspect of the present technology.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

In one aspect of the present technology, there is provided a conversion kit for replacing conventional sprocket wheels and endless tracks with sprocket wheel and endless tracks according to embodiments of the present technology. The sprocket wheel and endless tracks are configured to facilitate mounting thereof on a vehicle. Notably, the sprocket wheel and endless tracks can be mounted quickly and do not require modification of the vehicle to which they are being connected.

In another aspect of the present technology, there is provided an endless track of which a rigidity has been made more uniform. As a result of a rigidity of the endless track being more uniform along a length thereof, vibrations can be reduced.

The present technology will be described with reference to a military vehicle 20. Specifically, the military vehicle 20 is an armored personnel carrier 20 having a forward direction being indicated by arrow 21. It is contemplated that the military vehicle 20 could be another military vehicle such as a tank. It is to be noted, that the present technology could be used with other types of vehicles besides military vehicles. For example, the present technology could be used with agricultural vehicles such as tractors, with industrial vehicles such as bulldozers and skid-steer loaders, with utility vehicles, with exploratory vehicles and/or with all-terrain vehicles such as side-by-side vehicles or utility-terrain vehicles. It is also contemplated that the present technology could be used with trailers or other unpowered vehicles.

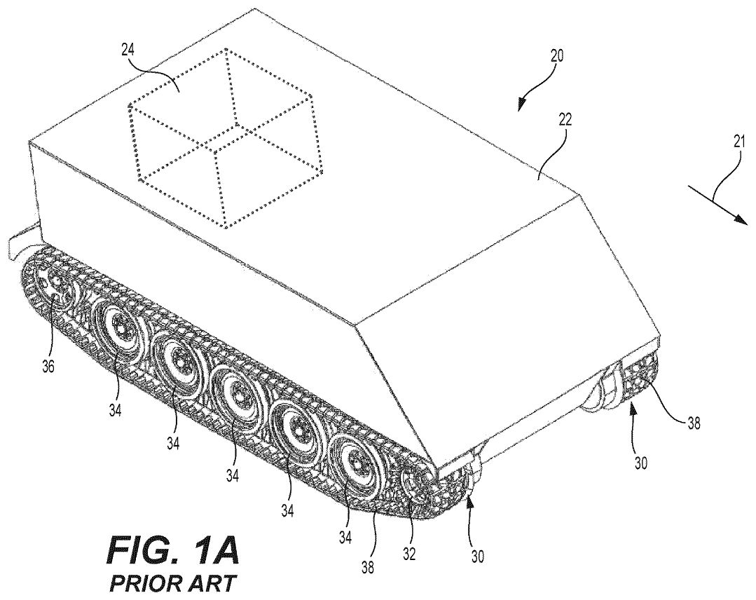

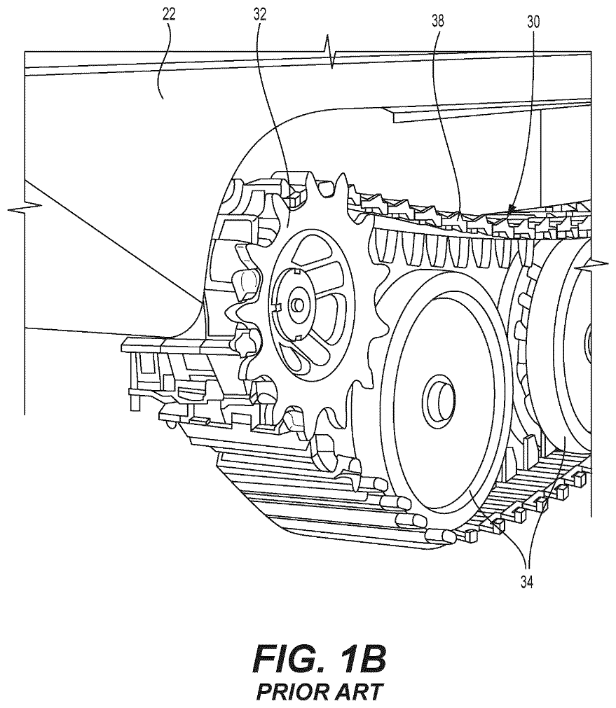

Referring to FIGS. 1A and 1B, the military vehicle 20 has a frame 22 and an engine 24 (both shown schematically) that is supported by the frame 22. The military vehicle 20 also includes, on either side thereof, track assemblies 30 as known in the art. The track assemblies 30 each include a sprocket wheel 32, a plurality of road wheels 34, an idler wheel 36 and a metallic endless track 38. Both of the sprocket wheels 32 are operatively connected to the engine 24, and are configured to drive their respective metallic endless tracks 38, and thus to drive the military vehicle 20. The road wheels 34 are configured to assist in guiding the metallic endless track 38. The idler wheels 36 are configured to adjust tension of the endless track 38.

In conventional systems, the metallic endless track 38 can be noisy and can be difficult to mount around the sprocket wheel 32, the plurality of road wheels 34, and the idler wheel 36.

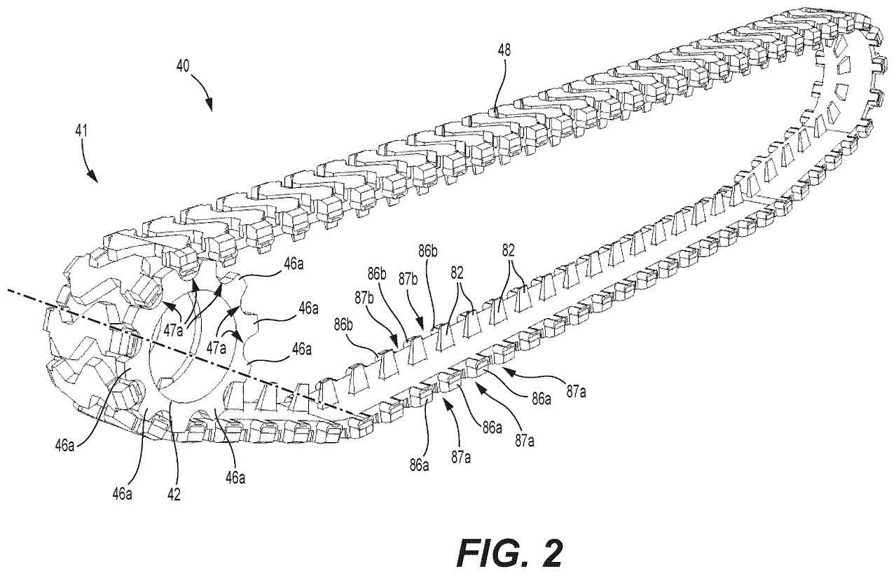

FIG. 2 illustrates a track assembly conversion kit 40 according to an embodiment of the present technology. The track assembly conversion kit 40 includes a replacement sprocket wheel 42 and a replacement endless track 48. In some embodiments, one conversion kit could include two replacement sprocket wheel assemblies 42, and two replacement endless tracks 48 (i.e., one conversion kit could include replacement for two track assemblies). As will be described in greater detail below, the track assembly conversion kit 40 is configured to replace the sprocket wheel 32, henceforth referred to as original sprocket wheel 32, with the replacement sprocket wheel 42 and to replace the metallic endless track 38, henceforth referred to as original endless track 38, with the replacement endless track 48. Thus, the track assembly conversion kit 40 provides components to replace the track assemblies 30 with track assemblies 41, where the track assemblies 41 each include the replacement sprocket wheel 42, the plurality of road wheels 34, the idler wheel 36, and the replacement endless track 48. Henceforth, the replacement sprocket wheel 42 will be referred to as sprocket wheel 42, and the replacement endless track 48 will be referred to as endless track 48. It is to be noted that according to some aspects of the present technology, the military vehicle 20 could originally be equipped with track assemblies having a sprocket wheel according to embodiments of the present technology and/or with endless tracks according to embodiments of the present technology.

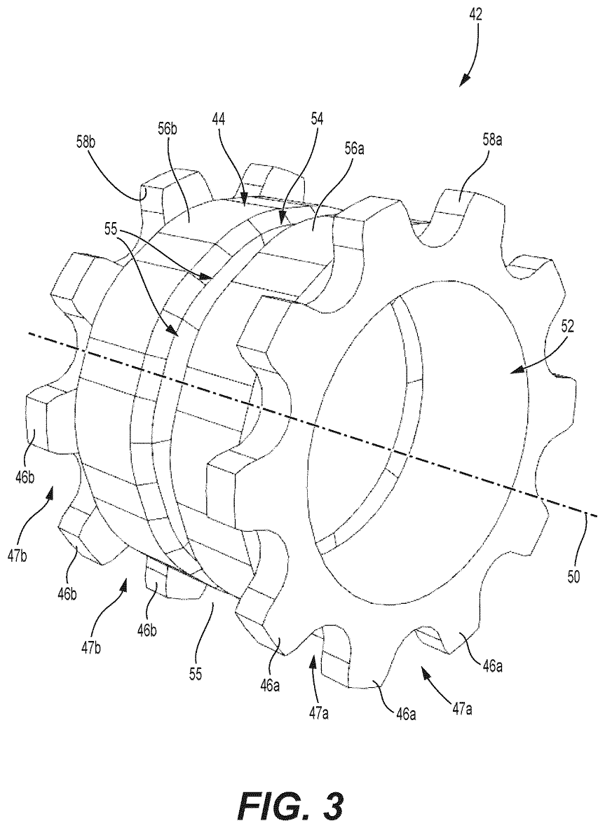

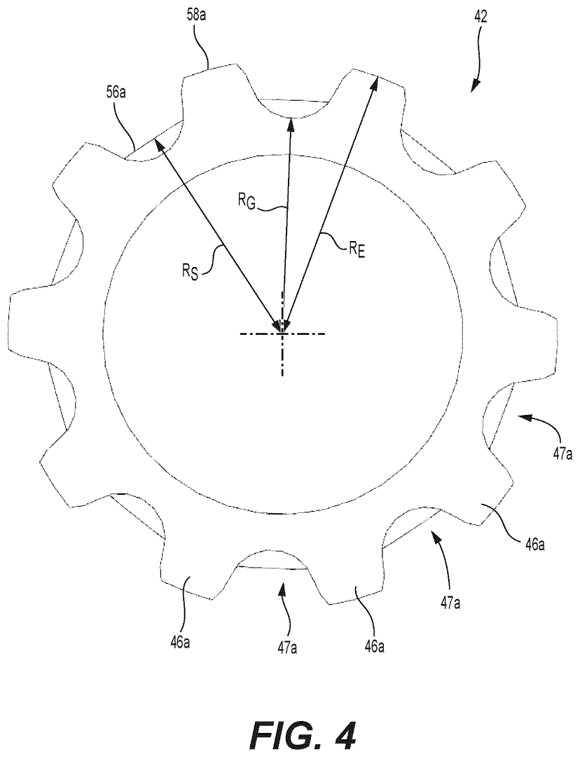

With reference to FIGS. 3 and 4, the sprocket wheel 42 will be described. The sprocket wheel 42 is operatively connected to the engine 24, and is rotatable about a sprocket wheel axis 50. The sprocket wheel 42 defines a central aperture 52 that is generally aligned with the sprocket wheel axis 50. In some embodiments, the central aperture 52 is configured to partially receive an axle (not shown) of the vehicle 20.

The sprocket wheel 42 has a rim 44 and a plurality of engaging elements 46a, 46b extending radially from the rim 44.

The rim 44 includes a central annular rim portion 54, side annular rim portions 56a, 56b disposed on either lateral side of the central annular rim portion 54, and edge annular rim portion 58a, 58b. The edge annular rim portion 58a is disposed on an outer lateral side of the side annular rim portion 56a, and the edge annular rim portion 58b is disposed on an outer lateral side of the side annular rim portion 56b.

The central annular rim portion 54 defines a plurality of circumferentially spaced apertures 55. As will be described below, the apertures 55 are configured to receive part of the endless track 48 therein. It is contemplated that in some embodiments, the central annular rim portion 54 could not define apertures therein.

The side annular rim portions 56a, 56b are configured to support a portion of the endless track 48. The side annular rim portions 56a, 56b each have a polygonal radial surface (i.e., there are a plurality of edges). It is contemplated that in some embodiments, the side annular rim portions 56a, 56b could be generally smooth radial surface (i.e., free of edges). A side radius Rs is defined from the sprocket wheel axis 50 to the radial surfaces of the side annular rim portions 56a, 56b.

The edge annular rim portion 58a has the plurality of engaging elements 46a, and the edge annular rim portion 58b has the plurality of the engaging elements 46b. The plurality of engaging elements 46a, 46b extend radially outwardly from, respectively, the edge annular rim portions 58a, 58b. Specifically, the engaging elements 46a, 46b are circumferentially spaced around the edge annular rim portions 58a, 58b. The engaging elements 46a, 46b, which may by referred to as “teeth”, are configured to engage with the endless track 48. A plurality of grooves 47a is defined between the plurality of engaging elements 46a, and a plurality of grooves 47b is defined between the plurality of engaging elements 46b. More precisely, one of the grooves 47a is defined between two adjacent engaging elements 46a, and one of the grooves 47b is defined between two adjacent engaging elements 46b. As will be described below, the grooves 47a, 47b are configured to receive part of the endless track 48 therein.

As best seen in FIG. 4, an engaging element radius RE is defined from the sprocket wheel axis 50 to an apex of one of the engaging element 46a. A groove radius RG is defined from the sprocket wheel axis 50 to a bottom of one of the groove 47a. As will become apparent from the following description, the relative sizes of the side radius Rs, the engaging element radius RE, and the groove radius RG can provide various advantages to the present technology. Notably, as will be described below, in one embodiment, where the side radius Rs is smaller than the engaging element radius RE, but greater than the groove radius RG, the sprocket wheel 42 can assist in reducing noise when the sprocket wheel 42 engages the endless track 48, and/or can assist in keeping constant tension within the endless track 48.

It is contemplated that in some embodiments, the sprocket wheel 42 could be configured to have one side annular rim portion 56a, and one edge annular rim portion 58a. In such embodiments, the engaging elements 46a and the grooves 47a would be present on one of the lateral sides of the sprocket wheel 42.

It is further contemplated that according to some aspects of the present technology, the sprocket wheel 42 could be different from the sprocket wheel 42 described hereabove. For example, in some embodiments, the sprocket wheel 42 could define recesses instead of having engaging elements extending radially therefrom (i.e., the sprocket wheel could be configured to be part of an internal drive configuration).

The sprocket wheel 42 is made of steel. It is contemplated that in some embodiments, the sprocket wheel 42 could be made of other material such as ultra-high molecular weight polyethylene (UHMW). In other embodiments, the sprocket wheel 42 could be made of steel covered by UHMW (which could assist in reducing noise generated thereby when engaging the endless track 48).

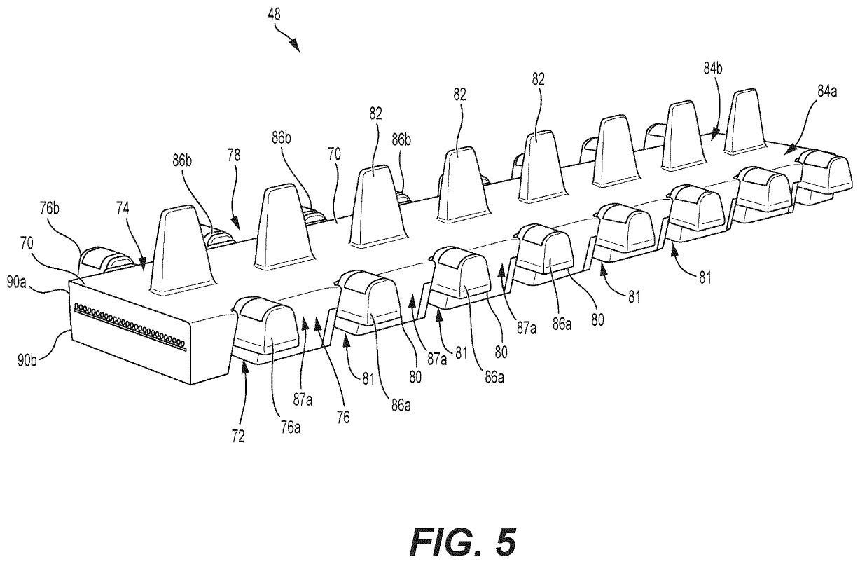

With reference to FIGS. 5 to 7, an embodiment of the endless track 48 will now be described in greater detail. The endless track 48 is configured to be installed around the sprocket wheel 42, the road wheels 34 and the idler wheel 36 without having to modify the military vehicle 20.

The endless track 48 has a body 70 that has an outer face 72 configured to contact a ground surface, an inner face 74 opposite to the outer face 72 configured to engage the sprocket wheel 42 and road wheels 34, and lateral faces 76, 78. Although in this embodiment, the body 70 is shown as one continuous loop, it is contemplated that in other embodiments, the endless track 48 could be a segmented track having at least two bodies connectable to one another.

The endless track 48 also has a plurality of outer lugs 80 extending outwardly from the outer face 72. The outer lugs 80 are longitudinally spaced from one another in a direction parallel to a longitudinal plane of the body 70. The outer lugs 80 define a plurality of channels 81, where each one of the plurality of channels 81 is defined between two outer lugs 80. It is contemplated that in some embodiments, the channels 81 could be defined by two or more outer lugs 80. The channels 81 are generally linear, though they could be shaped differently (e.g., curved) in other embodiments. The channels 81 extend generally perpendicularly to a longitudinal plane of the endless track 48. The channels 81 have an open end at the lateral face 76 and another open end at the lateral face 78. The channels 81 extend across a width of the endless track 48. In some instances, the channels 81 could extend across a portion of a width of the endless track 48. Each of the channels 81 also defines a center axis 81a. The outer lugs 80 and the channels 81 form a tread for engaging with the ground surface. The tread could vary from one embodiment to another. In some instances, the tread could depend on the vehicle 20 and/or the type of ground surface on which the vehicle 20 is destined to travel.

The endless track 48 also has a plurality of guide lugs 82 extending from the inner face 74. The guide lugs 82 are longitudinally spaced from one another. In the present embodiment, the guide lugs 82 are generally centered across a width of the body 70 such that the guide lugs 82 are central guide lugs 82. In other embodiments, there could be two or more laterally spaced rows of longitudinally spaced guide lugs 82. The guide lugs 82 can assist in guiding the endless track 48 by engaging with the sprocket wheel 32 by being received in the apertures 55 of the central portion 54, by engaging with the road wheels 34, and by engaging with the idler wheel 36.

On either lateral side of the guide lugs 82, the body 70 defines wheel paths 84a, 84b. The sprocket wheel 42 (side annular rim portions 56a, 56b of the), the road wheels 34 and the idler wheel 36 engage the endless track 48 at the wheel paths 84a, 84b. Additionally, the wheel paths 84a, 84b, as mentioned above, engage the side annular rim portions 56a, 56b of the sprocket wheel 42.

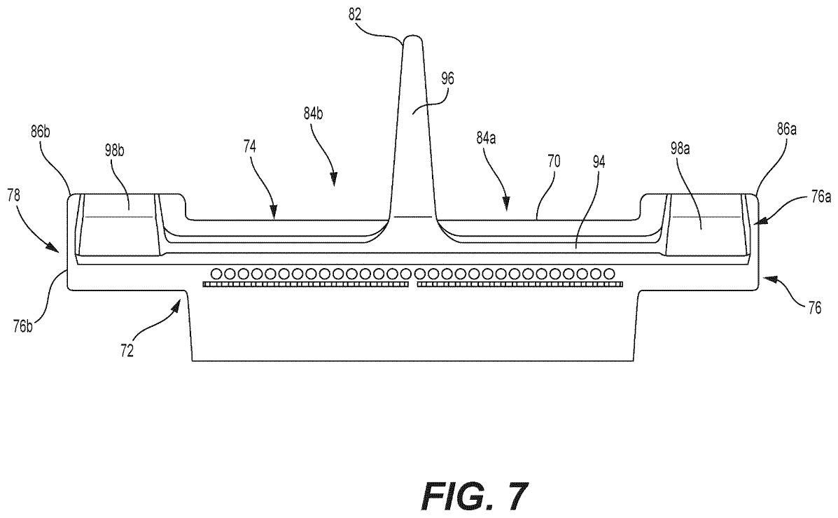

The endless track 48 further has a plurality of lugs 86a extending outwardly from the lateral face 76, and a plurality of lugs 86b extending outwardly from the lateral face 78. In the present embodiments, the lugs 86a, 86b extend generally perpendicularly from, respectively, the lateral faces 76, 78, but it is contemplated that in some embodiments, the lugs 86a, 86b could extend generally at an angle from, respectively, the lateral faces 76, 78. It is contemplated that in some embodiments, the plurality of lugs 86a, 86b could only extend from one of the lateral faces 76, 78. As will be described herebelow, the lugs 86a, 86b are configured to engage with the sprocket wheel 42 to drive the endless track 48. More precisely, the lugs 86a, 86b are respectively configured to be received in the grooves 47a, 47b of the sprocket wheel 42, and engage with, respectively, the engaging elements 46a, 46b. Since the lugs 86a, 86b engage the sprocket wheel 42 to drive the endless track 48, the lugs 86a, 86b can be referred to as driving lugs. As best seen in FIG. 7, an inner face of each of the lugs 86a, 86b is vertically above the inner face 74 of the body 70. The inner face of the lugs 86a, 86b being vertically above the inner face 74 can assist in guiding the endless track 48 and reducing chances of detracking by engaging with lateral surfaces of road wheels 34. It is contemplated that in some embodiments, the lugs 86a, 86b could be flush with the body 70.

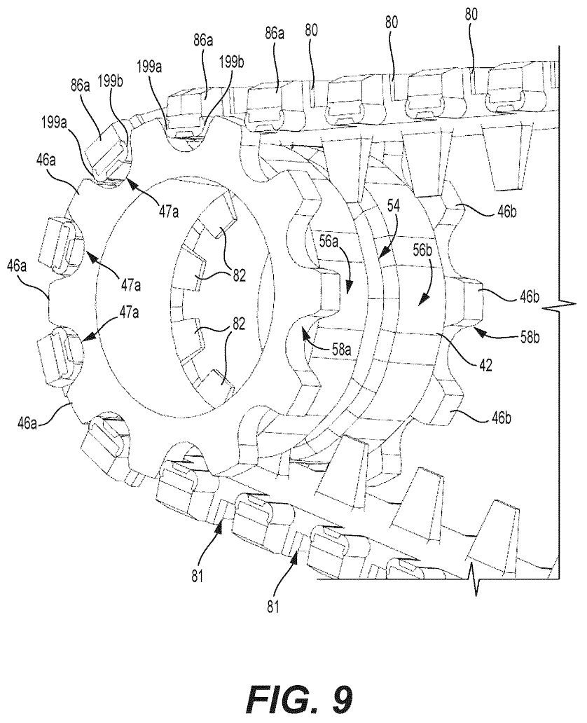

The endless track 48 also defines a plurality of gaps 87a, 87b. Specifically, the gaps 87a are defined between two adjacent lugs 86a, and the gaps 87b are defined between two adjacent lugs 87b. The gaps 87a, 87b are configured to receive, respectively, the engaging elements 46a, 46b when the sprocket wheel 42 and the endless track 48 are engaged to one another. The interaction between the engaging elements 46a, 46b and the gaps 87a, 87b is illustrated in FIG. 9.

With continued reference to FIGS. 5 to 7, the endless track 48 also has an upper layer of reinforcing members 90a, and a lower layer of reinforcing members 90b. It is contemplated that in some embodiments, there could be only a single layer of reinforcing members or three or more layers of reinforcing members. The upper and lower layers of reinforcing members 90a, 90b are layers of reinforcing cords 90a, 90b. The upper and lower layers of reinforcing members 90a, 90b are disposed within the endless track 48, extend longitudinally along a length of the endless track 48, and are for limiting longitudinal deformation thereof.

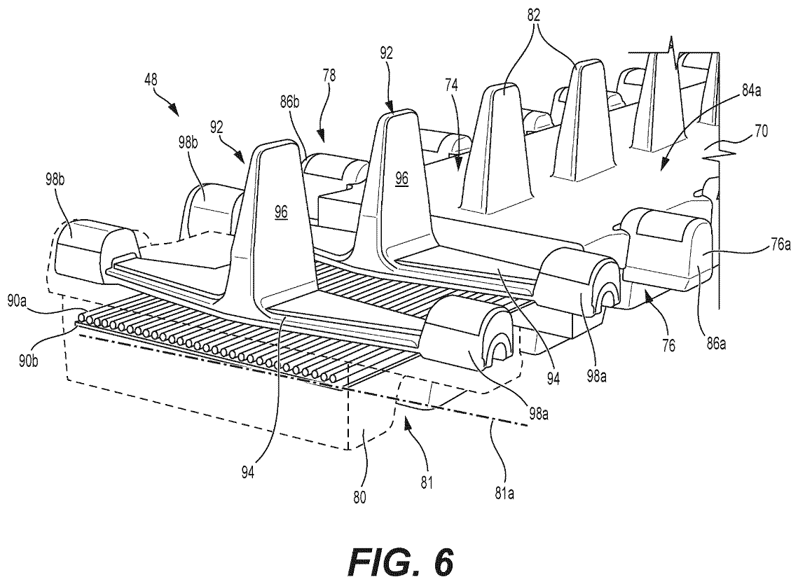

Referring to FIGS. 6 and 7, the endless track 48 also includes a plurality of reinforcing elements 92 (only two shown in FIG. 6) disposed along a length of the endless track 48 and disposed vertically above the upper and lower layers of reinforcing members 90a, 90b. The reinforcing elements 92 are longitudinally spaced from one another, and are longitudinally aligned with the lugs 86a, 86b. In some instances, each one of the reinforcing elements 92 could be longitudinally aligned with the center axis of one of the channels 81. As will be describe below, the reinforcing elements 92 are configured to reinforce the lugs 86a, 86b. In some embodiments, the reinforcing elements 92 could be embedded in the body 70. As the plurality of reinforcing elements 92 are all the same, only one will be described herewith.

Referring mostly to FIGS. 6 and 7, the reinforcing element 92 has a base portion 94 that extends laterally across the body 70. The reinforcing element 92 also has a central reinforcing portion 96 that extends vertically from a center of the base portion 94, an engaging portion 98a at one lateral side of the base portion 94, and an engaging portion 98b disposed at another lateral side of the base portion 94.

In some embodiments, the reinforcing element 92 extends across an entire width of the endless track 48. In such embodiments, the reinforcing element 92 extends from an outermost lateral segment 76a of the endless track 48 to the opposite outermost lateral segment 76b such that the reinforcing element 92 extends laterally, at least partially, within the lugs 86a, 86b, thereby reinforcing the lugs 86a, 86b.

The central reinforcing portion 96 is partially received in one of the guide lugs 82, and is configured to reinforce said guide lug 82. The engaging portion 98a extends within, and reinforces, the lug 86a, and the engaging portion 98b extends within, and reinforces, the lug 86b. The engaging portions 98a, 98b, like the central reinforcing portion 96a, extend vertically from the base portion 94. The engaging portions 98a, 98b, while reinforcing the lugs 86a, 86b, are also configured to guide the endless track 48, by engaging with lateral surfaces of road wheels 34. In some embodiments, the engaging portion 98a, 98b extending vertically can assist in providing a maximal engagement between the endless track 48 and the sprocket wheel 42, which can improve efficiency. In some embodiments, the engaging portions 98a, 98b could not extend vertically (i.e., the base portion 94 could be generally flat, besides for the central reinforcing portion 96).

The reinforcing element 92 are configured to reinforce the endless track 48, notably the body 70 and the lugs 86a, 86b from shear deformation when the sprocket wheel 46 engages with the endless track 48. As such, the reinforcing element 92 is made from a rigid material (i.e., is not bendable). In some instances, the reinforcing element 92 can be made from casted iron or forged steel. In some embodiments, the reinforcing element 92 can withstand pressures of about 835 MPa.

In some embodiments, the reinforcing elements 92 could be surrounded by an elastomeric material configured to, for example, enhance connection between the body 70 and the reinforcing elements 92.

Replacement elastomeric endless tracks that are known in the art are typically generally wider than the original endless track that is being replaced. This can be problematic, as it can require having to modify the vehicle. Contrary to known replacement elastomeric endless tracks, the width of the endless track 48 according to the present technology is generally equal to the width of the original endless track 38. The width of the endless track 48 being generally equal to the width of the original endless track 38 enables to mount the endless track 48 around the sprocket wheel 32, the road wheels 34 and the idler wheel 36 without having to modify the vehicle 20.

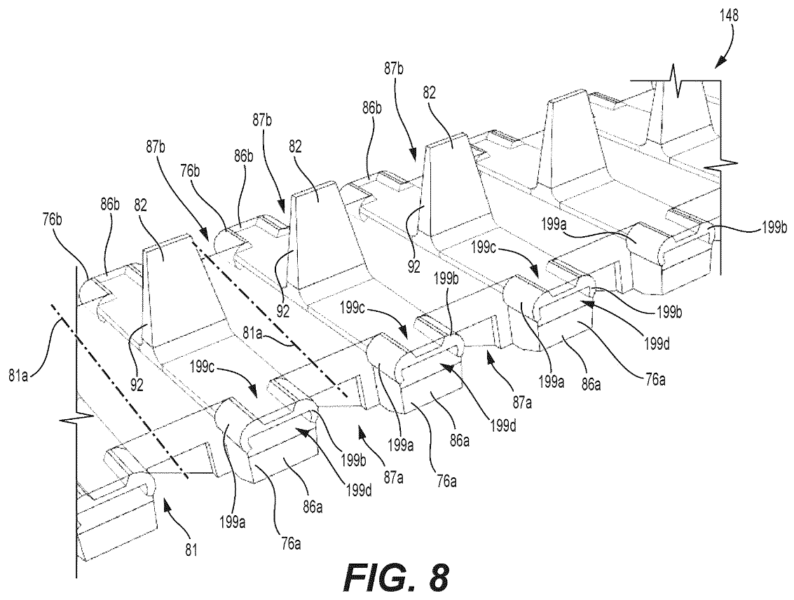

Referring to FIG. 8, an alternative embodiment of the endless track 48, namely endless track 148 will now be described. Features of the endless track 148 that are similar to those of the endless track 48 have been labelled with the same reference numerals and will not be described in detail again herewith.

The endless tracks 48, 148 are notably different from one another in that reinforcing elements 192 of the endless track 148 are different from corresponding reinforcing elements 92 of the endless track 48. Since the reinforcing elements 192 are similar, only one reinforcing element 192 will be described herewith.

In this embodiment, the reinforcing element 192 has notably been configured to reduce a mass thereof. Notably, engaging portions 198a, 198b of the reinforcing element 192 are different from the engaging portions 98a, 98b the reinforcing element 92. Each of the engaging portions 198a, 198b has a leading wall 199a and a trailing wall 199b. An inner recess 199c and an outer recess 199d are defined between the leading and trailing walls 199a, 199b of each of the engaging portions 198a, 198b. It is contemplated that in some embodiments, there could be more or fewer than two recesses. The presence of the upper and lower recesses 199c, 199d reduces the amount of material required to manufacture the reinforcing element 192, and thus reduces a weight of the reinforcing element. This reduction in weight can assist in reducing vibrations within the endless track 48 during operation, which in turn can enhance ride quality as well as extend life of various components of the vehicle 20. The presence of the upper and lower recesses 199c, 199d also provides an interlocking feature which can assist in fixing the reinforcing element 192 relative to the body 70 and relative to the lugs 86a, 86b.

Referring to FIG. 9, a description of the original sprocket wheel 32 and the original endless track 38 being replaced by the sprocket wheel 42 and the endless track 148 will now be provided. Although the description refers to the endless track 148, it is understood that the same generally applies to the endless track 48. In other words, the original track assembly 30 will be replaced with the track assembly 41. It is contemplated that in some embodiments, only one of the original endless track 38 and the original sprocket wheel 32 could be replaced (i.e., the sprocket wheel 42 could be used with an endless track not described herewith or the endless track 148 could be used with a sprocket wheel 42 not described herewith).

To begin, the original endless track 38 is dismounted from around the original sprocket wheel 32, the road wheels 34 and the idler wheel 36, and the original sprocket wheel 32 is operatively disconnected from the axle to which it is connected.

Then, the sprocket wheel 42 is operatively connected to the corresponding axle of the vehicle 20.

Then, the endless track 148 is mounted around the sprocket wheel 42, the road wheels 34 and the idler wheel 36. Since, as mentioned above, the width of the endless track 148 is similar to the width of the original endless track 38, the endless track 148 can be mounted around the sprocket wheel 42, the road wheels 34 and the idler wheel 36 without having to make any modification to the vehicle 20. For example, in an instance where the vehicle 20 has a skirt, there would be no need to remove a skirt of the vehicle 20. It is to be noted that the similarity in width between the original endless track 38 and the endless track 148 is enabled by the lugs 86a, 86b extending laterally instead of radially. Conventionally, driving lugs extend radially, and to withstand the heavy loads subjected thereto, these radially extending driving lugs must extend laterally, thereby resulting in the conventional elastomeric endless tracks having a larger width.

Furthermore, the mounting process (i.e., installation) of the endless track 148 is facilitated due to its configuration. Indeed, since the inner face 74 only has one set of protrusions (the guiding lugs 82), it is relatively easy to adjust the endless track 148 relative to the sprocket wheel 42, to the road wheels 34 and to the idler wheel 36, as there are less features that need alignment. In other words, the lugs 86a, 86b extending laterally instead of radially (i.e., extending from the lateral sides 76, 78 instead of the inner face 74) facilitate the installation of the endless track 148 around the sprocket wheel 42, the road wheels 34 and the idler wheel 36. The mounting process being facilitated can translate into an increase in mounting speed, which can be important in some scenarios, particularly in military scenarios, for example, where the mounting process is occurring in a conflict zone. The mounting process can even further be facilitated by omitting the guiding lugs 82.

Once the endless track 148 is mounted around the sprocket wheel 42, the road wheels 34 and the idler wheel 36, the vehicle 20 can be driven in part due to the engagement between the endless track 148 and the sprocket wheel 42. A description of this engagement will now be provided.

With continued reference to FIG. 9, the sprocket wheel 42 and the endless track 148 are positioned relative to one another such that the inner face 74 of the endless track 148 contacts the sprocket wheel 42. More precisely, the side annular rim portions 56a, 56b contact the endless track 148 at the wheel paths 84a, 84b. The annular rim portions 56a, 56b being polygonal can assist in driving the endless track 148. Some of the guiding lugs 82 are received in the apertures 55 of the central annular rim portion 54, some of the engaging elements 46a, 46b are received in the channels 81, some of the lugs 86a, 86b are received in the grooves 47b. Specifically, the lugs 86a, 86b extend across the rim 44 to be received in the groove 47a, 47b.

Because of the size difference between the side radius R_{S} and the groove radius R_{G} (the side radius R_{S} being greater than the groove radius R_{G}), when the lugs 86a, 86b are received in the grooves 47a, 47b, the inner face of the lugs 86a, 86b are vertically spaced from the bottom of their respective grooves 47a, 47b. In other words, the inner faces of the lugs 86a, 86b do not contact the bottom of their respective grooves 47a, 47b. Thus, the endless track 148 is in continuous engagement with sprocket wheel 42 at the side annular rim portions 56a, 56b. This configuration of continuous engagement between the endless track 148 and the sprocket wheel 42 as well as a spacing between the lugs 86a, 86b and the grooves 47a, 47b can assist in reducing noise that would otherwise occur when the inner face of the lugs 86a, 86b would abut the bottom of the grooves 47a, 47b. This engagement can also assist in decreasing vibrations in the endless track 148 and the sprocket wheel 42 and increase durability thereof. Furthermore, this configuration can assist in maintaining a constant tension throughout the endless track 148 so as to reduce chances of the endless track 148 detracking.

The lugs 86a, 86b extending from lateral faces 76, 78 instead of the inner face 74 can also assist in reducing chances of the endless track 148 from untracking, as lateral sides of the body 70, by abutting with the lugs 86a, 86b, can assist in guiding the endless track 148.

Additionally, debris such as rocks and mud are less likely to accumulate on the inner face 74 of the endless track 148, because there is only one set of protrusions (the guiding lugs 82). Furthermore, the rocks and muds can be pushed out from the inner face 74 through the grooves 47a, 47b. This can assist in enhancing ride quality and reducing vibrations, because the debris cannot impede engagement between sprocket wheel 42 and the endless track 148. Another advantage resulting from the lugs 86a, 86b extending from the lateral faces 76, 78 is that the chances of the lugs 86a, 86b from skipping with the grooves 47a, 47b (also known as “tooth skipping”) are reduced.

Furthermore, as mentioned above, the endless track 148 having the lugs 86a, 86b extending from the lateral faces 76, 78 enables the use of wider road wheels, as the road wheels are not limited by smaller road wheel paths (e.g., the road wheels could in some instances roll on the lugs 86a, 86b). This can extend life of the endless track 148 by reducing pressure subjected to the endless track 148, as well as by reducing heat generation, thereby extending life thereof.

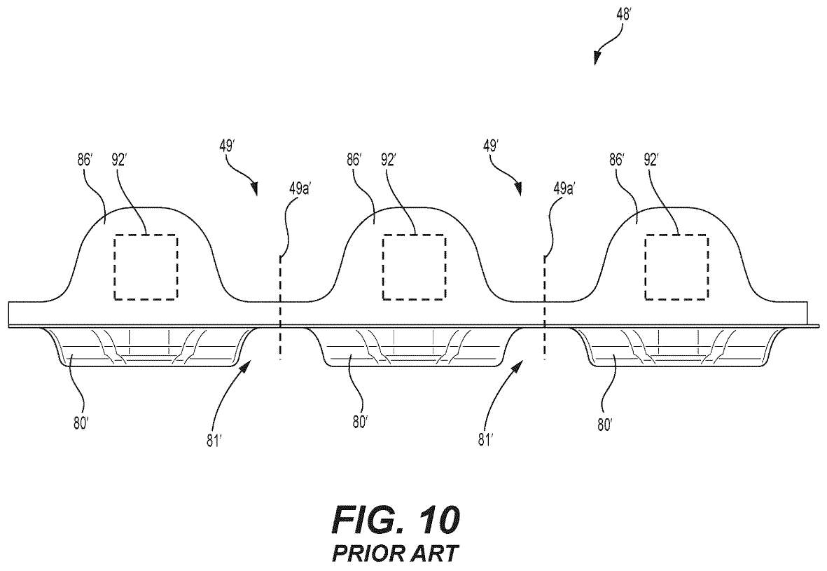

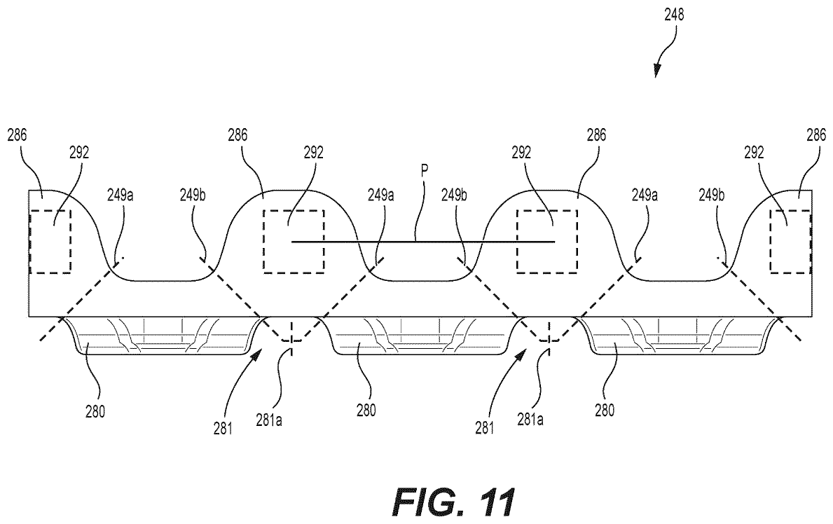

Referring to FIGS. 10 and 11, another aspect of the present technology will be described.

Referring to FIG. 10, an endless track 48′ as known in the art is shown. Features of the endless track 48′ similar to those of the endless tracks 48, 148 will not be described in detail. The endless track 48′ has the plurality of outer lugs 80′ that extend from the outer face 72′, and which define the plurality of channels 81′. The endless track 48′ further has driving lugs 86′ that extend from the inner face 74′ (instead of extending from the lateral faces as described hereabove with reference to endless tracks 48, 148). The outer lugs 80′ and the driving lugs 86′ are longitudinally aligned, as is conventional in known elastomeric endless tracks for assisting in making the endless track more flexible so that they may bend around idler and/or sprocket wheels. As such, the endless track 48′ has a plurality of flexible zones 49′, where each of the flexible zones 49′ are located between two adjacent outer lugs 80′ and two adjacent driving lugs 86 (i.e., at the channels 81′). Additionally, the endless track 48′ has a plurality of reinforcing elements 92′ embedded therein. Each of the reinforcing element 92′ is disposed in one of the inner lugs 80 (i.e., longitudinally offset from the flexible zones 49′). The shape and size of the reinforcing element 92′ could vary from one embodiment to another. Conventional elastomeric endless tracks are configured to flex (i.e., bend) at the flexible zones 49′ (i.e., channels). Generally, in conventional elastomeric endless tracks such as the endless track 48′, the bending at the flexible zones 49′ could be schematically shown as deforming about a virtual vertical axis 49a′. Thus, the endless track 48′ has a low rigidity at the flexible zones 49′ and has a high rigidity at the driving lugs 86′/outer lugs 80′.

Referring to FIG. 11, an endless track 248 according to an embodiment of an aspect of the present technology is shown. Features of the endless track 248 similar to those of the endless tracks 48, 148 will not be described in detail herewith.

In this embodiment, the endless track 248 has the plurality of outer lugs 280 that extend from the outer face 272, and which define the plurality of channels 281, where each of the channels 281 has the center axis 281a. The endless track 248 further has driving lugs 286 that extend from the inner face 74 (instead of extending from the lateral faces as described hereabove with reference to endless tracks 48, 148, although, as will be described below, it is contemplated that in some embodiments, the driving lugs 286 could extend from the lateral faces). In this embodiment, the endless track 248 has a plurality of reinforcing elements 292, where each of the reinforcing element 92 is disposed in one of the driving lugs 286 such that the reinforcing element 92 is aligned with channel 281. In the present embodiment, each of the reinforcing elements 92 is aligned with the center axis 281a of one of the channels 281. The shape and size of the reinforcing elements 286 could vary from one embodiment to another.

In this embodiment, the outer lugs 280 are longitudinally offset from the driving lugs 286. Specifically, the outer lugs 280 are longitudinally offset from the driving lugs 286 by about half a pitch of the driving lugs 286 (pitch P of the driving lugs 286 shown in FIG. 11). It is contemplated that the outer lugs 280 could be more or less offset from the driving lugs 286. As a result of the longitudinal offset of the outer lugs 280 relative to the driving lugs 286, a rigidity of the endless track 248 becomes more uniform. Indeed, offsetting the outer lugs 280 from driving lugs 286 reduces the rigidity at the driving lugs 286, and increases the rigidity between two driving lugs 286 (referred to previously as the flexible zone). Also, as a result of the longitudinal offset of the outer lugs 280 relative to the driving lugs 286, the endless track 248 is configured to bend more generally about virtual axes 249a, 249b. Each of the virtual axes 249a, 249b are at an angle to the outer and inner faces 72, 74. In some instances, the virtual axes 249a, 249b are symmetrical about a vertical plane extending therebetween.

With reference to the endless track 48′ depicted in FIG. 10, in operation, when one of the road wheels 34 rolls thereon, the endless track 48′ does not significantly deform when the road wheel 34 is at the driving lugs 86′, because the reinforcing element 92′ is rigid and does not bend because of the road wheels 34, and because the outer lug 80′ acts as a support on the ground. On the other hand, when the road wheel 34 is at the flexible portion 49′, the endless track 48 significantly deforms, as there is no support. The endless track 48′ particularly deforms about the vertical virtual axis 49a′. The difference in rigidities induces high vibrations in the track system, as the road wheel 34 alternately moves vertically by a substantial amount.

With reference to the endless track 248 of the present technology and as depicted in FIG. 11, in operation, when one of the road wheels 34 rolls thereon, the endless track 248 deforms when the road wheel 34 is at the driving lugs 286 (i.e., when the road wheel 34 is longitudinally aligned with a driving lug). It is to be noted that the endless track 248 deforms more than the endless track 48′ when the road wheel 34 is at the driving lug 86′. Specifically, the road wheel 34 is supported by the reinforcing element 292. A load borne by the reinforcing element 292 is transmitted to cables embedded in the endless track 248, which can limit the extent of deformation of the endless track 248. On the other hand, when the road wheel 34 is longitudinally between two driving lugs 286, the endless track 248 deforms. It is to be noted that the endless track 248 deforms less than the endless track 48′ when the road wheel 34 is in the flexible zone 49′. Specifically, the road wheel is supported by the outer lug 280, thereby limiting deformation of the endless track 248. Due to the outer lug 280, the endless track 248′ deforms about the virtual axes 249a, 249b. Since the difference in rigidities has been reduced in the endless track 248, vibrations in the track system are reduced, as the road wheel 34 alternately moves vertically by a smaller amount than the substantial amount. In other words, due to the reduction in rigidity difference (i.e., general uniformity in rigidities, particularly in comparison to known endless tracks), oscillation movement is reduced.

It is to be understood that the longitudinal misalignment between the driving lugs 286 and the outer lugs 280 can be applied to other types of track systems. For example, in the embodiment shown in FIG. 5, the outer lugs 80 are longitudinally offset from the driving lugs 86a, 86b, which extend from the lateral faces 76, 78 of the body 70. Thus, this aspect of the present technology is applicable to a variety of endless tracks. For example, the endless track could be configured to be an internal drive endless track or an external drive endless track.

Modifications and improvements to the above-described embodiments of the present invention may become apparent to those skilled in the art. The foregoing description is intended to be exemplary rather than limiting. The scope of the present invention is therefore intended to be limited solely by the appended claims.

1. A track assembly for a track vehicle, the track assembly comprising:
a wheel having a rim and a plurality of engaging elements extending radially outwardly from the rim, and the wheel defining a plurality of grooves therebetween; and
an endless track engageable with the wheel, the endless track having a reinforced elastomeric construction, and the endless track comprising:
a body having a longitudinal plane, and including:
an outer face for contacting a ground,
an inner face opposite to the outer face,
a first lateral face extending between the inner and outer faces, and
a second lateral face opposite to the first lateral face, and extending between the inner and outer faces, and
a plurality of lugs extending outwardly from the first lateral side, the plurality of lugs being longitudinally spaced from one another along the first lateral face,
wherein, each lug of the plurality of lugs is sized and shaped to be received in a respective groove of the plurality of grooves such that, a given one lug of the plurality of lugs extends across the rim of the wheel to be received in the respective groove.

2. The track assembly of claim 1, wherein the endless track includes a plurality of guide lugs extending from the inner surface.

3. The track assembly of claim 2, wherein the plurality of guide lugs is generally positioned parallel to a direction of the longitudinal plane of the body.

4. The track assembly of claim 2, wherein the endless track further comprises a plurality of reinforcing elements, each one of the plurality of reinforcing elements extending across a width of the endless track, and having a central reinforcing portion reinforcing a respective one of the plurality of guide lugs.

5. The track assembly of claim 1, wherein the endless track further comprises a plurality of reinforcing elements, each one of the plurality of reinforcing elements extending across a width of the endless track.

6. The track assembly of claim 5, wherein each one of the plurality of reinforcing elements extends from a first laterally outermost segment of the endless track to a second laterally outermost segment of the endless track.

7. The track assembly of claim 5, wherein each one of the plurality of reinforcing elements is generally flat.

8. The track assembly of claim 5, wherein each one of the plurality of reinforcing elements has an engaging portion for reinforcing a respective one of the plurality of lugs, and for engaging with the wheel.

9. The track assembly of claim 5, wherein each one of the plurality of reinforcing elements has a central reinforcing portion.

10. The track assembly of claim 1, wherein the reinforcing element has an interlocking feature for interlocking with the body.

11. The track assembly of claim 1, wherein the endless track further comprises at least one reinforcing member extending longitudinally along the length of the endless track.

12. The track assembly of claim 11, wherein the at least one reinforcing member is at least one layer of reinforcing members.

13. The track assembly of claim 12, wherein the at least one layer of reinforcing members is a layer of reinforcing cords.

14. The track assembly of claim 1, wherein when one of the plurality of lugs is received in one of the plurality of grooves, an inner surface of the one of the plurality of lugs is spaced from a bottom of the groove.

15. The track assembly of claim 1, wherein:
the plurality of lugs defines a plurality of gaps, and
when the wheel and the endless track are engaged to one another, one of the plurality of engaging elements is received in one of the plurality of gaps.

16. The track assembly of claim 1, wherein the rim has a first annular rim portion and a second annular rim portion, the plurality of engaging elements extend from the second annular rim portion, and when the wheel is operatively connected to the endless track, a portion of the inner face of the endless track is supported on the first annular rim portion.

17. The track assembly of claim 1, wherein:
the plurality of engaging elements of the wheel is a first plurality of engaging elements and the plurality of grooves defined therebetween is a first plurality of grooves, and the wheel further comprises a second plurality of engaging elements extending radially outwardly from the rim and defining a second plurality of grooves therebetween,
the plurality of lugs of the endless track is a first plurality of lugs, and the endless track further comprises a second plurality of lugs extending outwardly from the second lateral side, the second plurality of lugs being longitudinally spaced from one another along the second lateral side;
wherein:
each lug of the second plurality of lugs is sized and shaped to be received in a respective groove of the second plurality of grooves; and
each lug of the second plurality of lugs is sized and shaped to be received in a respective groove of the second plurality of grooves such that, a given one lug of the second plurality of lugs extends across the rim of the wheel to be received in the respective groove.

18. A vehicle comprising:
a body;
an engine supported by the body; and
at least two track systems according to claim 1, the at least two track systems being operatively connected to the engine.

19. The vehicle of claim 18, wherein the vehicle is a military vehicle.

20. A replacement wheel for replacing a wheel adapted for a metallic track and, the replacement wheel being configured to be in driving engagement with an endless track, the replacement wheel comprising:
a rim having a first annular rim portion and a second annular rim portion; and
a plurality of engaging elements disposed circumferentially around the second annular rim portion, the plurality of engaging elements extending radially outwardly from the second annular rim portion and defining a plurality of grooves therebetween.

21.-52. (canceled)
